(19) United States
(12) Patent Application Publication
(10) Pub. No.: US 2011/0261650 A1
(43) Pub. Date: Oct. 27, 2011

(54) METHOD FOR THE RADIATION MONITORING OF MOVING OBJECTS AND A RADIATION PORTAL MONITOR FOR CARRYING OUT SAID METHOD

(76) Inventors: Jury losifovich Olshansky, Saint-Petersburg (RU); Alexandr Georgievich Sorokin, Saint-Petersburg (RU)

(21) Appl. No.: 13/132,919

(22) PCT Filed: Dec. 4, 2009
(86) PCT No.: PCT/RU2009/000682

§ 371 Date: Jun. 4, 2011

(30) Foreign Application Priority Data
Dec. 9, 2008 (RU) 2008149122

(51) Int. Cl. G01S 15/58; G01S 15/08; G01T 1/16

(52) U.S. Cl. 367/89; 250/395; 367/99

(57) ABSTRACT

The invention relates to radiation monitoring and can be used for detecting radioactive materials during the unauthorized movement thereof. The method involves registering background gamma quanta and detecting a monitored object in a monitoring zone when the registered gamma radiation exceeds the background radiation. The moment when an object arrives at a distance Rπ from gamma radiation detectors is determined and the moment when the object moves away from the gamma radiation detectors to a distance Rγ is determined. The gamma quanta are registered from the moment when the object arrives at the given distance Rπ from the gamma radiation detectors to the moment when the object moves away from the gamma radiation detectors to the distance Rγ. Rπ=(0.8−1.2)(H+D) and Rγ=(0.8−1.2)(H+D), where H is the height of the horizontal plane that is the plane of symmetry of the position of the gamma radiation detectors; and D is half the distance between two gamma radiation detectors mounted at the same height. The monitor comprises the following components accommodated in a twin-post portal: a controller with a signaling unit, gamma radiation detectors with amplifiers and analog-to-digital converters, an object detection sensor based on an ultrasonic oscillation source and an ultrasonic oscillation receiver, a detection signal amplifier, a detector, a smoothing filter and an object detection and distance recording unit. The invention makes it possible to decrease the smallest detectable mass of radioactive material.

### PERTINENT ART

The invention relates to radiation monitoring and mainly be used for the detection of radioactive materials on the basis of registration of the emitted gamma rays when they are unauthorized moved through checkpoints of organizations and services.

### PRIOR ART

Among the methods of detection of radioactive material it is known a method for monitoring moving objects to detect fissionable nuclear materials (RU 2150127 C1, 2000), which provides the assignment of required level of probability of false alarm, recording and counting of background neutrons, calculation of the average number of background neutrons registered during the exposure time, the registration and counting of the neutrons during the exposure in the presence of an object in the control zone, the calculation of the threshold for the number of detected neutrons in the presence of an object in the control zone based on the required level of false alarm probability, a comparison of the number of detected neutrons in the presence of an object in a control zone with the calculated threshold and the formation of alarm based on the result of comparison. However, methods for the detection of fissile materials, which are based on the detection of neutrons emitted by these materials and to which the known method is related, in practice makes possible to detect only certain types of fissile materials of significant mass rarely used in the industry, but does not allow detecting these materials, having mass from units to tens of grams.

There are also known a method of identify the sources of ionizing radiation of a moving object (RU 2094821 C1, 1997), the method of radiation control of raw materials in vehicles (RU 2142145 C1, 1999), as well as the method that is embodied in the device of detection of radioactive materials (RU 2129289 C1, 1999), all of them are based on the detection of gamma radiation and in their common parts include measurement of background gamma radiation, determining whether the appearance of the test object in the control zone with the presence sensor, such as a registrar of the infrared radiation emitted by the controlled object, the measurement flux of gamma radiation at the location of the test object in the zone control, a comparison of the measured flux of gamma radiation with the flux of background gamma radiation and a decision about the presence of the controlled object of radioactive material in excess of the measured flux of gamma-ray flux of background gamma radiation. Usage of gamma radiation registration while providing these known methods of radiation control allows the detection of fissile materials, which have a mass equal to tens of grams.

The above mentioned known methods provide detection of radioactive materials in case if the controlled object is moved through a control zone in accordance with established rules, but do not allow to detect movement across the zone of control of radioactive materials in the case of intentional violations of these regulations by controlled objects. For example, the omission of radioactive materials while using these methods may occur in the case of intentional rapid movement of the object under control through a control zone or throw the container of radioactive material through a zone of control, which reduces the time that radioactive material spent in the control zone and causes a decrease in the number of registered gamma rays, which in this case will not exceed the established threshold value for it, specified in accordance with a nominal value of time that radioactive material spent in the control zone. In addition, since the threshold for the number of gamma rays registered when the test object presents in the control zone is established on the basis of pre-recorded background gamma-rays, intentional prolonged presence of controlled object with radioactive material or a container with of radioactive material near a zone of control leads to the increase in number of background gamma-rays registered by device and consequently to increase the preset threshold value, that can lead to this material non detection when you move the radioactive material through a zone of control even in accordance with the rules.

And finally, under implementation of these known methods gamma rays that are recorded after the triggering of presence sensor, are referred to as gamma rays emitted by the controlled object. The distance from the gamma-ray detectors to the test object, at which the presence sensor operates, is defined by the sensitivity of the sensor and the flux of infrared light emitted by the controlled object. In this regard, because the value of the time interval of gamma-rays registration when the test object located in the control zone has a fixed value at the beginning of gamma radiation registration at considerable distance the from test object to detectors of gamma radiation the share of gamma rays emitted by controlled object that detected by the gamma radiation detectors is turn out to be small, as a result probability of missing of detection of radioactive materials is increasing.

A similar phenomenon is observed when the sensor of the presence triggers when the controlled object is allocated close enough to the gamma-ray detectors, as a result a significant proportion of gamma rays emitted by a controlled object before the presence sensor alarm will be recorded by gamma-ray detectors, but mistakenly attributed to background gamma quanta. This would result in unreasonably inflated the threshold value for the registered gamma-rays, which can lead to missing radioactive material in its detection. In this case, due to a fixed value of the time interval of gamma radiation registration while the test object is locating in the control zone the gamma quanta counting will occur at a considerable distance of the object under control from gamma-ray detectors when it exits the control zone, when due to the large distance portion of recorded gamma-rays is quite small. This also caused an increase in the probability of non detection of radioactive material.

The closest in technical essence to the claimed method for the radiation monitoring of moving objects is a method, implemented in a known radiation portal monitor (RU 2191408 C1, 2002), which is used for the registration of radioactive emissions during the movement through it the moving objects with nuclear materials and radiation-hazardous substances. This method, which is the closest analog, provides the registration of background gamma rays with at least two gamma-ray detectors installed in the racks of portal, measurement of background gamma radiation flux, determining the fact of appearance of the test object in the control zone by presence sensor, registration gamma rays by at least two gamma-ray detectors installed in the portal racks in the presence of the test object in the control zone, the measurement of gamma-rays flux when the test object located in the control zone, comparing the measured flux of gamma-radiation with flux of background gamma radiation and a decision making about the presence of radioactive material in the controlled object when measured flux of gamma-ray is exceed flux of background gamma radiation.

In this method that is the closest analog the gamma rays are recorded after the presence sensor actuation, perceived as gamma rays emitted by the controlled object and the distance from the gamma-ray detectors to the test object, at which the presence sensor operates, is defined by the sensitivity of this sensor and the flux of infrared radiation emitted by the controlled object. Therefore, here as in the case of the all above mentioned methods, due to fixed magnitude of the value of time interval of gamma-rays registration in the presence of the test object in the control zone, in case of gamma-radiation registration at a considerable distance of object under control from gamma-ray detectors the fraction of the emitted by the controlled object gamma rays detected by gamma-ray detectors is turn out to be small which is resulted in increase of probability of missing a detection of radioactive materials.

Similar is happened if the presence sensor actuates when the controlled object is allocated close enough to the gamma-ray detectors, where a large proportion of the gamma rays emitted by the controlled object is registered before the alarm of the presence sensor will be recorded by gamma-ray detectors, but mistakenly attributed to background gamma rays. This would result in unreasonably inflated threshold value for the registered gamma-rays, which can lead to missing radioactive material in its detection. In addition, because the fixed value of the time interval of gamma radiation registration in the presence of the test object in the control zone the gamma quanta counting will occur at a considerable distance from the object under control to gamma-ray detectors when it exits the control zone, where due to the large distance the proportion of the detected gamma rays turn out to be quite small. This also causes an increase in the probability of passage of radioactive material.

These factors lead to an increase in the minimum mass of radioactive material, which with a given probability of overlooking and probability of false alarm can be detected by closest analogue method.

As with the implementation of the all above methods, the method that is the closest analog provides detection of radioactive materials in case if the controlled object is moved through a control zone in accordance with established rules. In the case of deliberate violations of these rules by the controlled objects during this method implementation the reliable detection of radioactive materials being moved through the zone of control is can not be provided.

First, the omission of radioactive material may occur in the case of intentional rapid movement of the test object through the control zone, or in case of throwing a container of radioactive material through the control zone, which reduces the time spent by radioactive material in the control zone and causes a decrease in the number of recorded gamma quanta, which in this case will not exceed the established for it threshold value, given in accordance with a nominal value of the residence time of radioactive material in the control zone. In addition, since the threshold for the number of gamma quanta registered in the presence of the test object in the control zone is established on the basis of pre-recorded background gamma-rays, intentional prolonged presence of controlled object with radioactive material near a zone of control or a container of radioactive material left near the zone of control, leads to an increase in the number of registered by device background gamma rays and thereby to increase the preset threshold value, that when you move the radioactive material through a zone of control, even in accordance with the established rules can lead to the omission of this material.

Therefore, the drawbacks of this closest equivalent method are essential minimum mass of radioactive material, which in its implementation may be detect, as well as very high probability of missing radioactive material, in particular, in deliberate opposition of controlled object to the detection procedure.

Among the radioactive materials detection devices the device for the detection of unauthorized movement of nuclear materials by individuals through the controlled space is known (RU 3832 U1, 1997). It is contains a two-frames portal, gamma radiation detection blocks placed in the portal, sensor of presence of individuals in a controlled space, metal-detector and apparatus for information processing and signaling.

It is also known a device for radioactive materials detection (RU 2129289 C1, 1999), which contains the block of gamma radiation detection, unit of neutron radiation detection, the presence sensor as a control object infrared radiation registrar, the intrusion sensor, controller, alarm unit, power supply, battery and remote control.

These known devices provide detection of background gamma radiation in the absence of the test object in the control zone, registration of gamma radiation in the presence of the test object in the control zone and a decision making about the presence of radioactive materials in the controlled object in case of excess of gamma quanta number that are registered in presence of the controlled object in the control zone established for its threshold value set on the basis of pre-recorded background gamma rays and the nominal residence time of the test object in the control zone.

Therefore, these known devices provide detection of radioactive materials in case if the controlled object is moved through a control zone in accordance with established rules, but do not allow to detect the movement across the zone of control of radioactive materials in the case of intentional violations of the controlled objects of these regulations. For example, the omission of radioactive materials by these devices can occur in case of intentional rapid movement of the controlled object, or throwing a container of radioactive material through a zone of control, which reduces the time that radioactive material spent in the control zone and causes a decrease in the number of registered by device gamma quanta which in this case will not exceed the established threshold value for it, given in accordance with a nominal value of the residence time of radioactive material in the control zone. In addition, since the threshold for the number of gamma quanta registered in presence of the test object in the control zone is established on the basis of pre-recorded background gamma-rays, intentional prolonged presence of controlled object with radioactive material or a container of radioactive material near a zone of control leads to increase in the number of registered by device background gamma-rays and consequently to increase the preset threshold value, that when you move the radioactive material through a zone of control, even in accordance with the established rules can lead to this material omission.

And finally, by use of these known devices gamma-rays that are registered after the presence sensor actuation, are referred to gamma rays emitted by the controlled object. The distance from the gamma-ray detectors to the test object, at which the presence sensor triggers, is defined by its sensitivity and the flux of infrared radiation emitted by the controlled object. In this regard, because the value of the time interval of gamma-rays registration in presence of the test object in the control zone has a fixed value at the beginning of gamma radiation registration at a considerable distance from the test object to detectors of gamma radiation the share of gamma rays emitted by a controlled object detected by the gamma radiation detectors is turn out to be small, as a result the probability of missing a detection of radioactive materials is increased.

A similar phenomenon is observed at the presence sensor actuation at the close enough distance from controlled object to gamma-ray detectors, in result a significant proportion of the gamma rays from a controlled object emitted before presence sensor actuation to be registered by gamma-ray detectors, but mistakenly attributed to background gamma quanta. This would result in unreasonably inflated the threshold value for the registered gamma-rays, which can lead to the omission of radioactive material in its detection. In this case, due to a fixed value of the time interval of gamma radiation registration in presence of the test object in the control zone counting of gamma rays will occur at a considerable distance of the object under control from gamma-ray detectors at the exit of the control zone, where due to the large distance the proportion of the recorded gamma-rays is turn out to be quite small. This also causes an increase in the probability of omission of radioactive material.

The closest in design to the claimed portal radiation monitor should be considered a portal radiation monitor (RU 2191408 C1, 2002), which contains a two-frames portal, placed in the portal scintillation gamma-ray detectors, placed in the portal object detection sensors, spectrometer amplifiers, analog-digital converters, block of light and sound alarm and a personal computer containing the system unit and display.

This portal radiation monitor, as well as all of the mentioned above known devices, provides registration of background gamma radiation in the absence of the test object in the control zone, registration of gamma radiation in the presence of the test object in the control zone and a decision on the presence of radioactive materials in the controlled object in case of excess of registered gamma rays registered in presence of the test object in the control zone established for its threshold value specified on the basis of pre-recorded background gamma rays and the nominal residence time of the test object in the control zone.

In this portal radiation monitor gamma rays, recorded after the presence sensor actuation, are perceived as gamma rays, emitted by the controlled object and hence the distances from the monitor and from gamma-ray detectors to the test object, at which the presence sensor triggers, are determined by sensitivity of the sensor and the flux of infrared radiation emitted by the controlled object. Therefore, as in the case of the mentioned above devices, for a fixed value of the time interval of gamma-rays registration in presence of the test object in the control zone, in case of beginning of gamma-radiation registration at a considerable distance from the object under control to gamma-ray detectors, fraction of the emitted gamma rays detected by gamma-ray detectors, is turn out to be small, as a result the probability of missing of radioactive materials is increased.

Similar is happens when the presence sensor triggers at the close enough distance from the controlled object to gamma-ray detectors, where a large proportion of the emitted gamma rays from a controlled object being registered before the presence sensor actuation will be recorded by gamma-ray detectors, but mistakenly attributed to background gamma rays. This would result in unreasonably inflated the threshold value for the registered gamma-rays, which can lead to missing radioactive material in its detection. In addition, because the fixed value of the time interval of gamma radiation registration in presence of the test object in the control zone the counting of gamma rays will occur at a considerable distance from the object under control to gamma-ray detectors at the exit of the control zone, where due to the large distance the proportion of detected gamma rays is turn out to be quite small. This also causes an increase in the probability of passage of radioactive material.

These same factors lead to an increase in the minimum mass of radioactive material, which a portal radiation monitor can detect with a given probability of permits and false alarms.

As with the above-mentioned devices, portal radiation monitor provides for detection of radioactive materials in case if the controlled object is moved through a control zone in accordance with established rules. In the case of deliberate violations of these rules by the controlled objects a portal radiation monitor does not allow reliable detection of radioactive materials being moved through the zone of control. Firstly, the omission of radioactive material may occur in the case of intentional rapid movement of the test object through the control zone, or in attempt of throwing a container of radioactive material through a zone of control, which reduces the time that radioactive material spent in the control zone and causes a decrease in the number of registered by portal radiation monitors gamma rays, which in this case will not exceed the established for it threshold value, given in accordance with a nominal value of the residence time of radioactive material in the control zone. In addition, since the threshold for the number of gamma rays registered in presence of the test object in the control zone is established on the basis of pre-recorded background gamma-rays, intentional prolonged presence of the controlled object with radioactive material near a zone of control or a container of radioactive material left near the zone of control, leads to an increase in the number of registered by device background gamma rays and thereby to increase the preset threshold value, that when you move the radioactive material through a zone of control, even in accordance with the established rules can lead to omission of this material.

Therefore, the disadvantage of the known radiation portal monitors, chosen for the closest equivalent, is an essential value of minimum mass of radioactive material, which the monitor is able to detect, as well as relatively high probability of missing of radioactive material, in particular, in case of deliberate opposite-actions by controlled object to its operation.

### DISCLOSURE OF THE INVENTION

The objectives of the present invention are to reduce the minimum detectable mass of radioactive material, as well as reduce the probability of passage of radioactive material, including the case of deliberate opposition from the object under control.

The problems are solved, according to the present invention, firstly, because the method for the radiation monitoring of moving objects, including:

a registration of background gamma quanta by at least two gamma-ray detectors,

counting the background gamma quanta recorded over a given time interval,

detecting the test object in the control zone,

a registration of gamma quanta by at least two gamma-ray detectors when controlled object is located in the control zone,

counting of gamma quanta recorded over a given time interval when controlled object is located in the control zone,

a comparison of number of gamma quanta recorded over the given time interval when controlled object is located in the control zone with the number of background gamma quanta recorded over the given time interval, and

providing a decision about the presence of the radioactive material in the controlled object at the excess of number of gamma quanta recorded over the given time interval when controlled object is located in the control zone over the number of background gamma quanta registered during the given time interval,

characterised in that

after the detection of the test object in the control zone a moment when the controlled object arrives at a given distance R_{P} from the gamma-ray detectors is determined,

a moment when the controlled object moves away from the gamma-ray detectors to a given distance R_{U} is determined and

a registration of gamma quanta when controlled object is located in the control zone is carried out from the moment when the controlled object arrives at the given distance R_{P} from the gamma radiation detectors to the moment when the controlled object moves away from the gamma radiation detectors to the given distance R_{U}, where the distance R_{P} and R_{U} is set according to the formula R_{P}=(0.8−1.2)·(H+D) and R_{U}=(0.8−1.2)·(H+D), where H—the height of the horizontal plane which is a symmetry plane of gamma-ray detectors location; D—the half of the distance between the two gamma-ray detectors installed at the same height.

In the case of the preferred embodiment of the method the ultrasonic vibrations are emitted in the control zone, ultrasonic vibrations reflected from the controlled object are accepted and converted into electrical signal, the electrical signal is increased, a component of the electrical signal proportional to the distance to the controlled object is selected by a bandpass frequency filter, the said component of electrical signal is detected and smoothed and the moment when the controlled object arrives at a given distance R_{P} from the gamma-ray detectors and the moment when the controlled object moves away from the gamma-ray detectors to a given distance R_{U} are determined by comparing the said component of the electric signal with at least one threshold value established in accordance with the values of the given distance R_{P} and the given the distance R_{U}.

The ultrasonic vibrations are emitted in the control zone, ultrasonic vibrations reflected from the controlled object are accepted and converted into electrical signal, the electrical signal is increased, a component of the electrical signal proportional to the speed of the controlled object is selected by a bandpass frequency filter, the said component of electrical signal is detected and smoothed, it compared with the established threshold, and in case of excess of the said component of the electric signal over the threshold the decision is made whether violation of the rules of movement through the control zone by the controlled objects was occurred.

The ultrasonic vibrations are emitted in the control zone, ultrasonic vibrations reflected from the controlled object are accepted and converted into electrical signal, the electrical signal is increased, a component of the electrical signal proportional to the intensity of the ultrasonic noise in the control zone is selected by a bandpass frequency filter, the said component of electrical signal is detected and smoothed and resulting smoothed component is subtracted from the electric signal.

The magnitude of time interval between the moments of electrical signals shaping by at least with two crossing sensors, which are designed as the source and receiver of optical radiation, placed opposite to each other on the opposite sides with respect to trajectory of controlled object movement in the control zone, and set in the plan at a given distance, is determined, the said magnitude of the time interval is compared with the established threshold, and decision is made about violation of the rules of movement through the control zone by the controlled object when threshold value exceeds the referred time interval.

The current time since the moment of the controlled object detection in the control zone until the moment of forming an electrical signal by at least one crossing sensor is measured, the current time is compared with established threshold, and decision is made about violation of the rules of movement through the control zone by the controlled object if the value of the current time exceeds the established threshold.

Performing in the this method implementation after the detection of the controlled object in the control zone the determination the moment when the controlled object arrives at a given distance R_{P} from the gamma-ray detectors, the determination the moment when the controlled object moves away from the gamma-ray detectors to a given distance R_{U} and the registration of gamma quanta when controlled object is located in the control zone carried out from the moment when the controlled object arrives at the given distance R_{P} from the gamma radiation detectors to the moment when the controlled object moves away from the gamma radiation detectors to the given distance R_{U}, where the distance R_{P} and R_{U} is set according to the formula R_{P}=(0.8−1.2)·(H+D) and R_{U}=(0.8−1.2)·(H+D), where H—the height of the horizontal plane which is a symmetry plane of gamma-ray detectors location; D—the half of the distance between the two gamma-ray detectors installed at the same height; which are achieved, for example, in the case of the preferred embodiment of the invention due to the emission in the control zone of ultrasonic vibrations, reception and conversion into an electrical signal of ultrasonic vibrations reflected by the controlled object, increasing the electrical signal, selecting by bandpass frequency filter of component of an electrical signal proportional to the distance to the controlled object, detection and smoothing of the said component of the electric signal, and determination of the moment when the controlled object arrives at a given distance R_{P} from the gamma-ray detectors and the moment when the controlled object moves away from the gamma-ray detectors to a given distance R_{U} by comparing the said component of the electric signal with at least one threshold value established in accordance with the values of the given distance R_{P} and the given the distance R_{U}, provides a reduction in the minimum detectable mass of radioactive material, as well as reduce the probability of omission of radioactive material. This statement is supported by the following considerations.

In a course of development of this method for the radiation monitoring of moving objects by the authors of the present invention for the minimal activity of the radioactive material, which with a given probability of false alarm and probability of omission of radioactive material presented method and realized it portal radiation monitor can detect with use, for example, of two gamma-ray detectors, the following an analytical formula was obtained

$$A = \frac{4 π V ( {{k}_{β} ( 2 RF / V + {{k}_{α} ( 2 RF / V )}^{\frac{1}{2}} )}^{\frac{1}{2}} + {{k}_{α} ( 2 RF / V )}^{\frac{1}{2}} )}{S η {\int }_{- R}^{R} \frac{1}{( {R}^{2} + {H}^{2} + {D}^{2} )} d R} ,$$

where V—a average speed of the controlled object in the control zone; k_{α} and k_{β}—a fractiles of a normal random variable defined by specified valid values, respectively, probability of omission of radioactive material and probability of false alarms; R—the distance from the controlled object to gamma-ray detectors, at which the registration of gamma-rays in presence of the test object in the control zone is started and finished; F—the number of detected background gamma quanta per second; S—a cross-sectional area of the scintillator gamma-ray detectors; η—an efficiency of gamma-ray detector; H—the height of the horizontal plane which is a symmetry plane of gamma-ray detectors location; D—the half of the distance between the two gamma-ray detectors installed at the same height. Here, the minimal activity of the radioactive material is expressed in the form of the number of gamma quanta emitted by them in a second.

This formula shows that the minimal activity A of the radioactive material, which with a given probability of false alarm and probability of radioactive material omission the present method and a portal radiation monitor that is realizing it can detect is a function of distance R from the controlled object to the gamma-ray detectors, at which the gamma-rays registration is started and finished in presence of the test object in the control zone. The study conducted by inventors showed that the function has a pronounced minimum whose position depends only on the values of height H of the horizontal plane which is the symmetry plane of gamma-ray detectors location, and of half D of the distance between the two gamma-ray detectors installed at the same height. The change of the values of the rest of variables of the reduced formula (V, k_{α}, k_{β}, F, S and η) is only a change in the absolute value of the minimum of this function, but does not change its position. The studies of that function extremum by differentiation it with respect to distance R from the controlled object to the gamma-ray detectors, at which the gamma-rays registration is started and finished in presence of the controlled object in the control zone, and equating the resulting derivative to the zero resulted to the equation that is not presented here due to its complexity and its analytical solution related to the distance R was not resolved by the authors of the present invention.

However, the solutions of this equation, obtained by the authors by numerical methods, have concluded that this function has a minimum at the value of the distance R from the controlled object to the gamma-ray detectors, at which the gamma-rays registration is started and finished in presence of the controlled object in the control zone, which falls close to a value equal to H+D, where H—the height of the horizontal plane which is a symmetry plane of gamma-ray detectors location; D—the half of the distance between the two gamma-ray detectors installed at the same height. In this case, a significant increase in the value of this function compared to its minimum value is observed in the output of value of the distance R from the test object to the gamma-ray detectors, at which the gamma-rays registration is started and finished in presence of the controlled object in the control zone, beyond the range of 0.8·(H+D) to 1.2·(H+D).

Therefore, the determination the moment when the controlled object arrives at a given distance R_{P} from the gamma-ray detectors, the determination the moment when the controlled object moves away from the gamma-ray detectors to a given distance R_{U} and the registration of gamma quanta when controlled object is located in the control zone from the moment when the controlled object arrives at the given distance R_{P} from the gamma radiation detectors to the moment when the controlled object moves away from the gamma radiation detectors to the given distance R_{U} (where the distance R_{P} and R_{U} is set according to the formula R_{P}=(0.8−1.2)·(H+D) and R_{U}=(0.8−1.2)·(H+D), where H—the height of the horizontal plane which is a symmetry plane of gamma-ray detectors location; D—the half of the distance between the two gamma-ray detectors installed at the same height) reduces the minimum mass of radioactive material, which method allows to detect.

Thus the most rational choice of moment of the start of gamma-rays registration in presence of the controlled object in the control zone is prevented the registration of gamma radiation at a considerable distance of the controlled object from gamma-ray detectors, when the fraction of gamma rays emitted by controlled object is detected by gamma-ray detectors is turn out to be small as a result the probability of missing radioactive materials is decreased.

The same reason prevents the start of gamma rays registration at the close allocation of the controlled object to the gamma-ray detectors, where a significant fraction of gamma rays emitted by controlled object before the registration start could be detected by gamma-ray detectors, and thus wrongly attributed to background gamma quanta, thus prevents the unreasonable increase in the threshold values for the detected gamma rays, resulting in reduced probability of radioactive material omission. For the same reason the counting of gamma quanta at a considerable distance of the controlled object from gamma-ray detectors at the exit of the control zone is not produced, where due to the large distance the proportion of the detected gamma rays is sufficiently small, which also causes a decrease in the probability of omission of radioactive material.

Using in the preferred embodiment of the present method the emission of ultrasonic vibrations from a control zone, reception and conversion into an electrical signal ultrasonic vibrations reflected from a controlled object, enhancement of electrical signal, selection with a bandpass frequency filter of the component of an electrical signal proportional to the speed of the controlled object, detection and smoothing of the said component of the electric signal, comparing it with determined threshold and in excess of the said component of the electric signal threshold decision on the violation of a controlled object of the rules of movement through the control zone allows to compare the speed of the controlled object with its maximum allowable value set by the rules of movement of the controlled object through the control zone. This reveals the fact of intentional violation of these rules by a controlled object, which is associated with an attempt to implement them throw of the container with radioactive material through a control zone, which reduces the time spent radioactive material in the control zone and causes a decrease in the number of registered gamma quanta. Revealing this fact reduces the probability of omission of radioactive material.

Performing in the best embodiment for the method of emission of ultrasonic vibrations into the control zone, reception and conversion into an electrical signal the ultrasonic vibrations reflected from the controlled object, enhancement of electrical signal, selection of component of the electrical signal proportional to the intensity of ultrasonic noise in the control zone by a bandpass frequency filter, detection and smoothing of the said component of the electric signal, and subtracting the resulting smoothed component from the electrical signal provides an additional reduction of the probability of omission of radiation material in the conditions of ultrasonic noise action. Such noise may occur, for example, when working near the control zone of electrical machines, such as ventilation and air conditioning, and electrical tools. The above actions performed in carrying out the present method, provide a selection of electric signal of ultrasonic noise and the subtraction of its constant component, partially offsetting the effect of such noise on the results of registration of the distance to the controlled object and its velocity.

Using in the case of the best embodiment of the invention the determination of the time interval between the moments of electrical signals forming by at least two crossing sensors, which are made in the form of an optical radiation source and a optical radiation receiver, placed opposite to each other on opposite sides with respect to the trajectory of a controlled object in control zone, and set in the plan at a given distance, comparing the obtained values of the time interval to the determined threshold and the decision of the violation of a controlled object of the rules of movement through the control zone when threshold value is exceed the said time interval allows on the basis of the known preset distance between the crossing sensors and the said time interval to estimate the speed of the controlled object through the control zone, and compare it with the maximum allowable value determined by the established rules of movement in the control zone. This allows establishing the fact of intentional rapid movement of the controlled object through the control zone, which reduces the probability of omission of radioactive materials.

The current time measurement since the controlled object detection moment in the control zone until the moment of forming an electrical signal with at least one crossing sensor, comparing the said current time to the threshold determined for it and a decision on the violation of a controlled object of the rules of movement through the control zone in the excess of the current time value of its threshold makes it possible to establish the fact of deliberate long-term presence of controlled object with radioactive material near a control zone in order to increase the number of detected background gamma quanta that in case of movement of the radioactive material through a control zone, even in accordance with the rules may leads to omission of this material. The establishment of such a fact of intentional violations of the rules of movement through the control zone reduces the probability of omission of radioactive material.

Noticed is testified about the resolution of the declared above problems by the present invention due to the presence of the listed above traits by claimed method for the radiation monitoring of moving objects.

The problems are solved, according to the present invention, secondly, by the fact that a radiation portal monitor comprising a two-frame portal, allocated in the portal controller with a connected alarm unit, at least two gamma-ray detectors with series connected incorporated amplifier and analog-digital converter connected to the input of the controller, and object detection sensor, characterised in that it is equipped with an series connected object detection signal amplifier, the first detector, the first smoothing filter and unit of object detection and distance recording that is connected by the output to the input of controller, at that the object detection sensor is designed as a source and receiver of ultrasonic vibrations, and the input of the object detection signal amplifier connected to the output of ultrasonic vibrations receiver.

The radiation portal monitor can be equipped with amplification automatic control unit connected by the input to the output of the first smoothing filter and the object detection signal amplifier is arranged with possibility to adjust its amplification ratio and its amplification control input is connected to the output of amplification automatic control unit.

The unit of object detection and distance recording of the radiation portal monitor contains the series connected a first bandpass frequency filter, a second detector, a second smoothing filter and a distance registration threshold device with a threshold level equals to the value of the electric signal at its input when the controlled object is located at a given distance from the gamma-ray detectors, equals to (0.8−1.2)·(H+D), where H—the height of the horizontal plane which is a symmetry plane of gamma-ray detectors location; D—the half of the distance between the two gamma-ray detectors installed at the same height.

The radiation portal monitor can be equipped with object speed recording unit containing series-connected a second bandpass frequency filter, a third detector, a third smoothing filter and speed registration threshold device, and the input of the said second bandpass frequency filter and the output of the said speed registration threshold device are connected respectively to the output of the first smoothing filter and the input of the controller.

The radiation portal monitor can be equipped with noise recording unit, comprising series-connected third bandpass frequency filter, the fourth detector and a fourth smoothing filter, and the input of the third bandpass frequency filter connected to the output of the first smoothing filter and the output of the fourth smoothing filter connected to the inputs of the first and second bandpass frequency filters.

The radiation portal monitor can be equipped with at least two crossing sensors installed in the alignment of the two-frame portal at the same horizontal plane at the assigned distance from each other, each of which is designed as a optical radiation source and a optical radiation receiver mounted on the opposite frames of the portal across from each other, and with at least two circuits containing series-connected a crossing signal amplifier and a crossing signal threshold device, and the crossing signal amplifier input is connected to the optical radiation receiver output, and the output of crossing signal threshold device is connected to the controller input.

The radiation portal monitor equipped with the series connected object detection signal amplifier, the first detector, the first smoothing filter and unit of object detection and distance recording that is connected by the output to the input of controller, at that the object detection sensor is designed as a source and receiver of ultrasonic vibrations, and the input of the object detection signal amplifier connected to the output of ultrasonic vibrations receiver, when in the best invention embodiment the unit of object detection and distance recording of the radiation portal monitor contains the series connected a first bandpass frequency filter, a second detector, a second smoothing filter and a distance registration threshold device with a threshold level equals to the value of the electric signal at its input when the controlled object is located at a given distance from the gamma-ray detectors, equals to (0.8−1.2)·(H+D), where H—the height of the horizontal plane which is a symmetry plane of gamma-ray detectors location; D—the half of the distance between the two gamma-ray detectors installed at the same height; provides a reduction of the minimal mass of radioactive material detectable by monitor and reduction the probability of non detection of radioactive material. This is confirmed by the following considerations.

Firstly, the inventors found that at the beginning and at the end of registration of gamma radiation emitted by the controlled object at a given distances from the range of radiation portal monitors which has in its plane installed gamma-ray detectors, to the controlled object respectively at the time of its entrance into the control zone and at its exit from control zone for a given location of gamma-ray detectors installed in the radiation portal monitor exist such values of these distances at which with given probability of omission and probability of false alarm detection of radiation material of the smallest mass is provided. As it was described in details in the disclosure of the nature of the claimed method for radiation monitoring of moving objects, the values of these distances falls in the range respectively, R_{P}=(0.8−1.2)·(H+D) and R_{U}=(0.8−1.2)·(H+D) where H—the height of the horizontal plane which is a symmetry plane of gamma-ray detectors location; D—the half of the distance between the two gamma-ray detectors installed at the same height. In this connection, assignment of the threshold level of the distance registration threshold device precomputed for specified values of these distances taking into account transfer ratio of electronic path from the receiver of ultrasonic vibrations to the second smoothing filter inclusive, or established by experiment allows to record the gamma radiation emitted by the controlled object, since the moment when the controlled object approached the monitor range at the specified distance until the moment when the controlled object passed the monitor range withdrew from it to the specified distance. As a result, the radiation portal monitor provides practical detection of the minimum detectable mass of radioactive material with the given probability of omission and probability of false alarm.

Secondly, it prevents registration of gamma radiation of the controlled object at a considerable distance from the monitor range as at the object entrance of the control zone, as at the object exit of the control zone, when the share of emitted by controlled object gamma rays detected by gamma-ray detectors due to the considerable distances renders as minor. This leads to an increase of number of detected gamma quanta emitted by the controlled object, and therefore reduces the probability of omission of radioactive material. In addition, it prevents a faulty classification of the recorded gamma quanta emitted by controlled object located at a short distance to the count of background gamma quanta, thus preventing unjustified overestimation of the threshold value for the detected gamma quanta and the associated increase in the probability of omission of radioactive material.

According to the authors of the invention the radiation portal monitor equipped at the best variant of its realization with amplification automatic control unit connected by the input to the output of the first smoothing filter, the implementation of the object detection signal amplifier with the ability to adjust its amplification ratio and connecting its amplification control input to the amplification automatic control unit output also provides an additional reduction of the minimum mass of radioactive material that the monitor is able to detect and reduce the probability of omission of radioactive material. This is because the use of amplification automatic control allows partially compensates the changes in the signal detection of the object that caused the change of such air parameters of the control zone, where ultrasonic vibrations propagates, as temperature, pressure and humidity, and also maintains a constant component of signal of object detection in the middle of its dynamic diapason. Therefore, the results of determination of the moment of approach and removal of the controlled object at a given distances by comparing the distance registration threshold device with the established threshold level will be less dependent on the parameters of the control zone air.

According to the authors of the invention the radiation portal monitor equipped at the best variant of its realization with the object speed recording unit that contains series-connected second bandpass frequency filter, the third detector, the third smoothing filter and the speed registration threshold device when the input of the second bandpass frequency filter and the output of speed registration threshold device connected respectively to the output of the first smoothing filter and the input of the controller, additionally reduces the probability of omission of radioactive material in case of deliberate counter actions of the controlled object to the radiation portal monitoring procedure. This is explained by the provision of radiation portal monitor with these units that can distinguish the object detection signal component that is proportional to the object speed, and establish that violations of the rules of movement in the control zone by the controlled objects such as attempt of performing a throw of container with radioactive material through control zone in case if this component exceeds the threshold level of the speed registration threshold device.

Moreover, the provision of radiation portal monitor at the best embodiment with at least two crossing sensors which are installed in the range of two-frame portal in the alignment of a single horizontal plane at a specified distance from each other, each of which is designed as a optical radiation source and a optical radiation receiver mounted on the opposite frames of the portal across from each other, and at least two circuits containing series-connected a crossing signal amplifier and a crossing signal threshold device when the input of crossing signal amplifier is connected to the output of the optical radiation receiver, and the output of crossing signal threshold device is connected to the controller input also reduces the probability of omission of radioactive material in condition of controlled object counteraction to the radiation portal monitors functioning.

Firstly, if case of violation of the rules of movement of the controlled object through the control zone which is determined based on the result of comparison the threshold level of speed record threshold devices with the object detection signal component that is proportional to its speed, based on lack of detection of signal of the portal alignment crossing, which is formed by optical radiation receiver, it gives possibility to confirm that the throw of radioactive material container was performed through control zone.

Secondly, if object detection signal exceeds the threshold level in the distance registration threshold device, but signal of alignment intersection from optical radiation receiver is absent it allows to identify unauthorized movement of a person in the control zone that may be associated with attempt to bypass the alignment screen in the course of control zone crossing, or an attempt to provide the increase of background gamma radiation in the control zone thus hiding illicit radioactive material, planning to carry out it later.

And, thirdly, it allows on the basis of the known preset distance between the crossing sensors and the resulting time interval between the electrical signals generated by these sensors at the controlled object intersection of monitor alignment, to evaluate the speed of controlled object movement through the control zone, and compare it with the maximum allowable value determined by the established rules of movement in the control zone. This allows us to establish the fact of intentional rapid movement of the controlled object through the control zone, which reduces the probability of omission of radioactive material.

The radiation portal monitor equipped in the best form of its realization with noise recording unit, comprising series-connected third bandpass frequency filter, the fourth detector, and a fourth smoothing filter when the input of the third bandpass frequency filter connected to the output of the first smoothing filter and the output of the fourth smoothing filter connected to the inputs of the first and second bandpass frequency filters, provides a further reduction in the probability of omission of radioactive material at a ultrasonic noise condition. Such noise may occur, for example, at the electrical machines operation near the control zone, such as ventilation and air conditioning, or electrically operated tools. The noise recording unit which is a part of the radiation portal monitor provides a selection of the interference signal of ultrasonic noise from the object detection signal and the subtraction of its constant component by the first and second bandpass filters from the object detection signal, partially compensating the effect of such noise on the controlled object detection results and its speed registration.

Noted demonstrates the resolution of the above declared problems by the present invention due to the presence of above traits of the radiation portal monitor.

### BRIEF DESCRIPTION OF DRAWINGS

FIG. 1 shows the block circuit diagram of the preferred embodiment of the radiation portal monitor according to the authors of the present invention, which allows to carry out the claimed method for radiation monitoring of moving objects and is the subject of the present invention, in the case of use of two gamma-ray detectors, where 1—a portal, 2 and 3—respectively a first and second gamma-ray detectors, 4—a source of ultrasonic vibrations, 5—a receiver of ultrasonic vibrations, 6 and 7—respectively a first and second crossing sensors, 8—a unit of the object detection and distance recording, 9—an object speed recording unit, 10—a noise recording unit, 11 and 12—respectively a first and second detector amplifiers, 13 and 14—respectively a first and second analog-digital converters, 15 and 16—respectively a first and second crossing signal amplifiers, 17—object detection signal amplifier, 18—an amplification automatic control unit, 19, 20, 21 and 22—a first, second, third and fourth detectors, respectively, 23, 24, 25 and 26—a first, second, third and fourth smoothing filters, respectively, 27, 28 and 29—respectively a first, second and third bandpass frequency filters, 30—a distance registration threshold device, 31—speed registration threshold device, 32 and 33—a first and second crossing signal threshold devices, respectively, 34—controller and 35—alarm unit.

FIG. 2 shows the placement of the two gamma-ray detectors in the radiation portal monitor and position in this case the horizontal plane which is a symmetry plane of gamma-ray detectors arrangement, where 36—the horizontal plane which is a symmetry plane of gamma-ray detectors arrangement.

FIG. 3 shows the placement of four gamma-ray detectors in the radiation portal monitor and position in this case the horizontal plane which is a symmetry plane of gamma-ray detectors arrangement.

FIG. 4 shows the placement of six gamma-ray detectors in the radiation portal monitor and position for this case the horizontal plane which is a symmetry plane of gamma-ray detectors arrangement.

FIG. 5 shows the placement of eight gamma-ray detectors in radiation portal monitor and position for this case the horizontal plane which is the symmetry plane of the gamma-ray detectors.

FIG. 6 shows the graphical dependence of minimal activity A of radioactive material, that present method and radiation portal monitor equipped with two gamma-ray detectors allows to detect with assigned probability of false alarm and probability of omission of radioactive material at the distance R from controlled object to gamma-ray detectors, at which the gamma-rays registration is started and finished when the controlled object is located in the control zone. This dependence was obtained for the values of the average speed V of the test object in control zone of V=2 m/s, the fractiles of a normal distribution of random variable of k_{α}≈4 and k_{β}≈1.64, defined by specified valid values of probability of omission of radioactive material equal to 0.05, and probability of false alarm equal to 10⁻⁴, the number F of background gamma quanta detected per second, F=500 s⁻¹, area S of cross-sectional of the scintillator gamma-ray detector S=0.016 m², the effectiveness η of gamma quanta detection by gamma-ray detector of q=0.64, the height H of the horizontal plane 36 (see FIG. 2-5), which is a plane of symmetry of gamma-ray detectors location, H=1 m, and half D the distance between the two gamma-ray detectors installed at the same height, D=0.5 m. Here, the minimum activity A of radioactive material expressed as the number of gamma quanta emitted by them in the second, and its minimum value of A=1.38·10⁵ s⁻¹ is reached at the distance R from the controlled object to the gamma-ray detectors from which the gamma-rays registration is started and finished when the controlled object is located in the control zone equals to 1.6 m, i.e. R≈1.067·(H+D).

### PREFERRED EMBODIMENT OF THE INVENTION

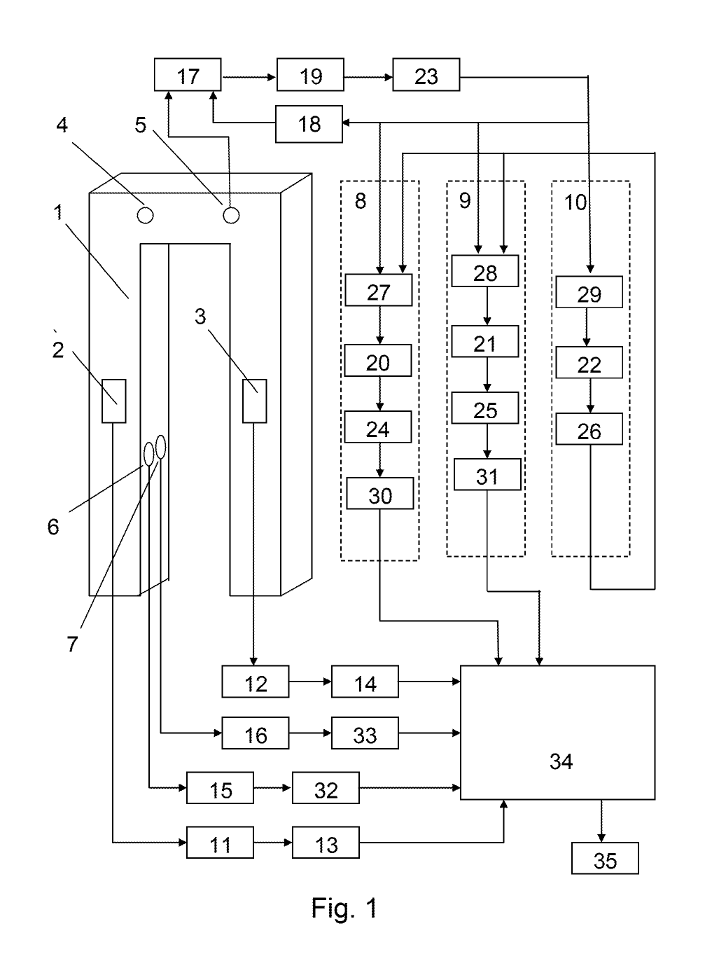

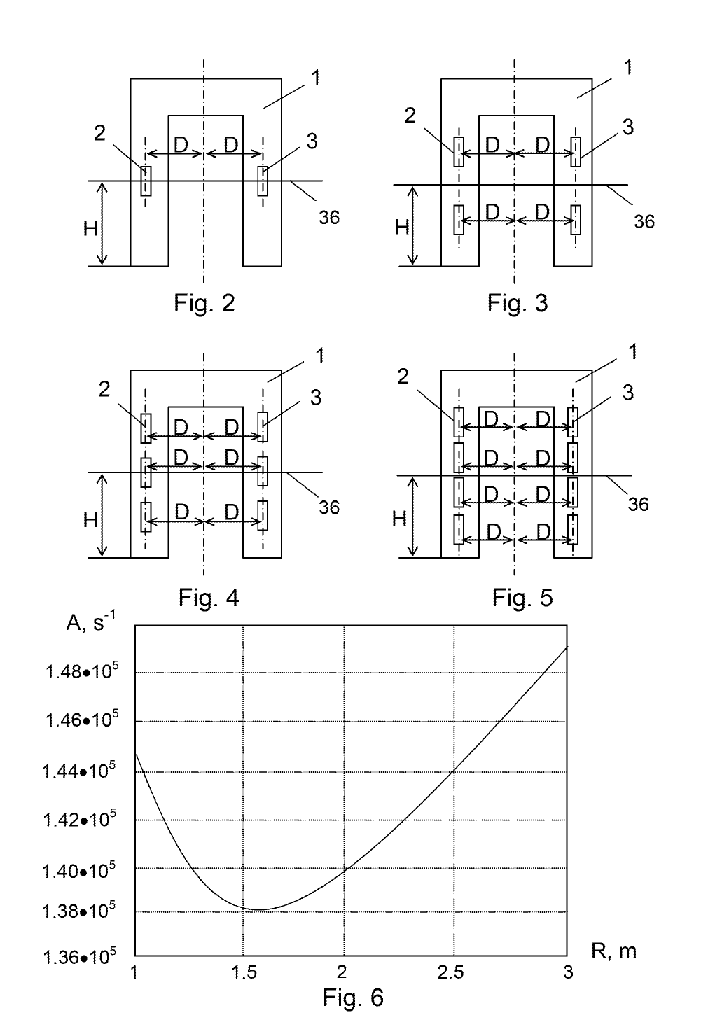

A radiation portal monitor which allows to perform the claimed method of radiation monitoring for moving objects and which is the subject of the present invention comprises (see FIG. 1) a portal 1, which has two frames with a passage between them that allows the movement of the controlled object and host all other radiation portal monitor elements. The first and second gamma-ray detectors 2 and 3 are installed in the portal 1 stands, each gamma-ray detector 2 and 3 contains an inorganic scintillator, based on sodium iodide activated with thallium, and photoelectron multiplier tube optically connected with the scintillator. According to the authors of the present invention it is preferable to use an even number of gamma-ray detectors, for example in practice from two to eight, half of them are placed in one frame of portal 1, and the other half—in the another (see FIG. 2-5). On the outer surface of a portal 1 the sensor of object detection is installed, which is designed as a source 4 of ultrasonic vibrations, performed with the possibility of emission of ultrasonic waves with a frequency of, for example, 40 kHz, and the receiver 5 of ultrasonic vibrations that coherent with source on properties of sensitivity and frequency of ultrasonic vibrations. The two crossing sensors are installed in the alignment of a portal 1, i.e. the first and second crossing sensors 6 and 7, each of which is designed as a optical radiation source (is not visible on FIG. 1, but located on the right rack of portal 1), performed with the possibility of emission of optical radiation of near infrared spectrum, and optical radiation receiver, coherent in spectral sensitivity characteristics with the optical radiation source mounted on the opposite racks of portal 1 next to each other. The first and second crossing sensors 6 and 7 are installed in a same horizontal plane at a set distance from each other.

Radiation portal monitor contains series-connected first detector amplifier 11, whose input is connected to the output of the first gamma-ray detector 2, and the first analog-digital converter 13 and also series-connected the second detector amplifier 12, whose input is connected to the output of the second gamma-ray detector 3, and a second analog-digital converter 14. Radiation portal monitor includes series-connected first crossing signal amplifier 15 that connects the input to the output of the first crossing sensor 6, and the first crossing signal threshold device 32 and series-connected the second crossing signal amplifier 16 that connects the input to the output of the second crossing sensor 7, and the second crossing signal threshold device 33.

Radiation portal monitor includes series-connected object detection signal amplifier 17, whose input is connected to the output of receiver 5 of ultrasonic vibrations, the first detector 19 and the first smoothing filter 23, whose output is connected to the inputs of the unit 8 of the object detection and distance recording, object speed recording unit 9 and noise recording unit 10, as well as amplification automatic control unit 18 connected by the input to the output of the first smoothing filter 23 and by the output to the input of the object detection signal amplifier 17. Unit 8 of the object detection and distance recording contains the connected in series first bandpass frequency filter 27, connected by the input to the output of the first smoothing filter 23 and having a bandwidth from 75 Hz to 3.5 kHz, the second detector 20, the second smoothing filter 24 and distances registration threshold device 30. The distances registration threshold device 30 has a threshold level, which is equal to the value of the electric signal on its input at the moment of location of controlled object at a given distance from the gamma-ray detectors, equal to (0.8−1.2)·(H+D), where H—height horizontal plane 36, a plane of symmetry of the gamma-ray detectors arrangement; D—half the distance between the two gamma-ray detectors installed at the same height (see FIG. 2). In this case, the best result is achieved when this distance is equal to H+D. The object speed recording unit 9 contains a series-connected second bandpass frequency filter 28 connected by the input to the output of the first smoothing filter 23 and having a bandwidth from 3.6 to 12 kHz, the third detector 21, the third smoothing filter 25 and speed registration threshold device 31. The speed registration threshold device 31 has a threshold level, which equals the value of the electrical signal on its input at maximum speed of controlled object that permitted by the rules of movement through the control zone. A noise recording unit 10 contains connected in series a third bandpass frequency filter 29, connected by the input to the output of the first smoothing filter 23 and having a bandwidth from 15 to 60 kHz, a fourth detector 22 and a fourth smoothing filter 26, connect by the outputs to the inputs of the first and second bandpass frequency filters 27 and 28.

In addition, radiation portal monitor comprises a controller 34 and connected to its output the alarm unit 35, realized with the possibility of audible and visual alarm, and inputs of the controller 34 are connected to the outputs of the first and second analog-digital converters 13 and 14, as well as to the outputs of the distance registration threshold device 30, the speed registration threshold device 31, the first crossing signal threshold device 32 and the second crossing signal threshold device 33. As the controller 34 may be used by a microcomputer system unit or a personal computer.

Radiation portal monitor that allows the implementation of the claimed method and is the subject of the present invention works as follows.

When the radiation portal monitor is turned on the voltage is supplies to the all its nodes. As a result, the source 4 of ultrasonic vibrations emits ultrasonic waves into the space of control zone, and the optical radiation sources of the first and second crossing sensors 6 and 7 form the light beams that propagate through the portal 1 alignment in the direction of the optical radiation receivers, respectively the first and second crossing sensors 6 and 7 and fall on their sensitive surfaces.

When the controlled object is absent in the control zone the background gamma quanta fall into the scintillators of the first and second gamma-ray detectors 2 and 3 and cause light flashes into them, that light flux falls on the photocathode of photoelectron multiplier tubes of first and second gamma-ray detectors 2 and 3, resulting in the conversion of gamma quanta into electrical impulses with amplitude that proportional to the gamma quanta energies. Gamma quanta electrical impulses from output of first and second gamma-ray detectors 2 and 3 enhanced by the first and second detector amplifiers 11 and 12, arrive respectively to the first and second analog-digital converters 13 and 14, which convert the amplitudes of these electrical pulses into digital codes received by the controller 34. The controller 34 by comparing the digital codes to the established upper and lower thresholds identifies pulses of gamma quanta which energies fall within specified range determined by the energy of gamma quanta emitted by controlled radioactive materials, and calculates the number of detected gamma quanta relates them to the background gamma quanta because the input of the controller 34 does not fall a signal of controlled object from the distance registration threshold device 30 of the unit 8 of object detection and distance recording. As a result, dividing the number of registered background gamma quanta by the time interval of their registration, controller 34 determines the average background gamma quanta registered per unit time, and based on the average number of background gamma quanta registered per unit time, determines the threshold for the number of gamma quanta detected when the controlled object is located in the control zone, which is essential for a decision making about the presence of radioactive materials. In this state signaling controller 34 is not issued alarm at alarm unit 35.

When a controlled object is located in the control zone it reflects ultrasonic vibrations that propagates to the receiver 5 of ultrasonic vibrations, which converts them into an electrical signal of object detection, which after intensification by the object signal detection amplifier 17, detection by first detector 19 and the smoothing of pulsations by first smoothing filter 23 goes to the inputs of automatic amplification control unit 18, the first bandpass frequency filter 27 of unit 8 of the object detection and distance recording, the second bandpass frequency filter 28, object speed record unit 9 and the third bandpass frequency filter 29 of noise recording unit 10. In this case, automatic amplification control unit 18 alters the amplification ratio of object detection signal amplifier 17 for maintenance a constant component of the object detection signal in the middle of its dynamic range, providing a partial compensation for changes in the object detection signal, which is caused by a change of control zone air parameters where ultrasonic vibrations propagates such as temperature, pressure and humidity.

The first bandpass frequency filter 27 due to chosen bandwidth selects from the object detection signal its harmonic components, whose amplitude is proportional to the distance to the controlled object. After the detection of those harmonic components of signal by the second detector 20 and the smoothing of pulsations by second smoothing filter 24 signal is arrived into the distance registration threshold device 30, which threshold level corresponds to a given distance from an approaching controlled object from which gamma quanta emitted by a controlled object is started to be registered. Wherein said predetermined distance is chosen for these quantities and placement of gamma-ray detectors so that provides a possibility for radiation portal monitors to detect the minimum mass of radioactive material.

At this time, the first and second gamma-rays detectors 2 and 3 as discussed above continue to register not only the background gamma quanta but also gamma quanta from the controlled object. Information about amount of registered gamma quanta by the same manner stored in the controller 34. When approaching a controlled object to the portal 1 at a predetermined distance equal to, for example, H+D, the signal at the input of the distance registration threshold device 30 exceeds its threshold level, thus due to a signal given by distance registration threshold device 30 controller 34 starts counting the number of registered gamma quanta, relating them to gamma quanta from the controlled object.

In a course of controlled object movement through the portal 1, it crosses portal alignment, and its body with the time consistently shades the light beams falling from the optical radiation sources on the sensitive surface of optical radiation receivers of first and second crossing sensors 6 and 7. The resulting changes of the incident light beams due to this shadowing are converted by the optical radiation receivers of first and second crossing sensors 6 and 7 into the electrical signals that are amplified by the first and second crossing signal amplifiers 15 and 16 received respectively in the first and second crossing signal threshold devices 32 and 33. When these signals exceeds the threshold levels of the first and second crossing signal threshold devices 32 and 33 they consistently with the time, in accordance with the movement of the controlled object, form the output signals that arrive to the controller 34. In accordance with the sequence of arrival of these signals the controller 34 determines the direction of the controlled object movement and uses this information to calculate the number of controlled objects that pass through the radiation portal monitor in one direction or another. In addition, the controller 34 determines the value of the time interval between the moments of these signals arrival and based on the known distance between the optical radiation receivers of first and second crossing detectors 6 and 7 determines the speed of the controlled object movement through a portal 1. Then the controller 34 compares the value of the controlled object speed with the maximum allowable speed values stored in its memory which could be equal to, for example, 1.4-1.7 m/s and assigned in accordance with the rules of movement in the control zone, and in case of excess of this maximum value it generates and transmits an alarm signal to alarm unit 35, which produced audible and visual alarm signals of the violation of rules of movement in the control zone that is associated with an accelerated movement through the portal 1.

While the controlled object is passing through the portal 1 and moving away the signal at the input of the distance registration threshold device 30 decreases. When the controlled object is removed from the range of the portal 1 to a distance equal to the H+D, this signal becomes less than the threshold level of the distance registration threshold device 30. The signal at its output will disappear, and the controller 34 stops count the gamma quanta that were registered when the controlled object was located in the control zone, and compares the counted number of gamma quanta with the previously calculated threshold value based on the detection of background gamma quanta. In case if counted number of gamma quanta exceeds the computed above threshold value controller 34 passes to unit 35 alarm signal, which alerts the light and sound alarms about passage of radioactive material through the portal 1. Otherwise, the alarm signal is not generated and not transmitted to the alarm unit 35.

The alarm unit 35 also notifies about the possible tampering of controlled object in the control zone by the alarm signal from the controller 34 if within a specified time interval after admission to the controller 34 signal from the distance registration threshold device 30, indicates the presence of the controlled object in the control zone, the controller 34 does not received signals from the first and second crossing sensors 6 and 7, confirming the intersection of alignment of portal 1. Such unauthorized actions of controlled object can be aimed to the passing the control zone round the portal 1, or can be aimed onto the reduction of radiation portal monitor sensitivity at the expense of raising the threshold value for the number of detected gamma quanta resulting from, for example, placement for a some time in control zone or near it a container with radioactive material, simulating increased intensity of background gamma radiation.

Simultaneously, the second bandpass frequency filter 28 due to the chosen bandwidth selects from the object detection signal those harmonic components, which amplitude is proportional to the speed of the controlled object movement. After the detection of those harmonic components of signal by the third detector 21, and smoothing the ripple by third smoothing filter 25 signal arrives to the speed registration threshold device 31, which threshold level corresponds to the maximum permitted speed of the controlled object movement through the control zone, equal to, for example, 1.4-1.7 m/s. If the threshold level was not exceeded by the signal, the speed registration threshold device 31 does not trigger out and does not deliver a signal to the controller 34. In this case, the radiation portal monitor operates as it was described above.

If the signal at the input of the speed registration threshold device 31 exceeds the threshold level, indicating that speed of the controlled object in the control zone exceeds the limit; the speed registration threshold device 31 activates, forms at the input of the controller 34 the appropriate signal. As a result, the controller 34 generates and transmits to the alarm unit 35 an alarm signal indicating a possible attempt to implement a throwing of controlled object of container with radioactive material through the control zone. The alarm unit 35 notifies about the violation of rules of movement through the control zone with appropriate light and sound alarms.

In the case of operations at elevated ultrasonic noise condition, for example, work of electrical machinery ventilation and air conditioning, cleaning tools or other electrical tools the third bandpass frequency filter 29 due to chosen bandwidth selects the harmonic components caused by the ultrasonic noise from the object detection signal. After detection of those harmonic components of signal by fourth detector 22 and smoothing fluctuations by fourth smoothing filter 26 the signal of constant component of the ultrasonic noise arrives to the inputs of the first bandpass frequency filter 27 and the second bandpass frequency filter 28, where it subtracts from the object detection signal, partially offsetting of the effect of ultrasonic noise on the controlled object detection results and register its speed and distance.

### INDUSTRIAL APPLICABILITY

The prototypes of radiation portal monitor which is the subject of the present invention and enables the claimed method for radiation monitoring of moving objects were produced and their laboratory and field tests were conducted by the authors of the present invention. The tests shown that, compared with a closest analog of such technical solution, the presented radiation portal monitor provides a reduction in the minimum detectable mass of radioactive material, as well as reduces the probability of omission of radioactive material, including the cases of deliberate actions from the controlled object.

1. A method for the radiation monitoring of moving objects, including:
a registration of background gamma quanta by at least two gamma-ray detectors,
counting the background gamma quanta recorded over a given time interval,
detecting the test object in the control zone,
a registration of gamma quanta by at least two gamma-ray detectors when controlled object is located in the control zone,
counting of gamma quanta recorded over a given time interval when controlled object is located in the control zone,
a comparison of number of gamma quanta recorded over the given time interval when controlled object is located in the control zone with the number of background gamma quanta recorded over the given time interval, and
providing a decision about the presence of the radioactive material in the controlled object at the excess of number of gamma quanta recorded over the given time interval when controlled object is located in the control zone over the number of background gamma quanta registered during the given time interval,
characterised in that
after the detection of the test object in the control zone a moment when the controlled object arrives at a given distance R_{P} from the gamma-ray detectors is determined,
a moment when the controlled object moves away from the gamma-ray detectors to a given distance R_{U} is determined and
a registration of gamma quanta when controlled object is located in the control zone is carried out from the moment when the controlled object arrives at the given distance R_{P} from the gamma radiation detectors to the moment when the controlled object moves away from the gamma radiation detectors to the given distance R_{U}, where the distance R_{P} and R_{U} is set according to the formula R_{P}=(0.8−1.2)·(H+D) and R_{U} (0.8−1.2)·(H+D), where H—the height of the horizontal plane which is a symmetry plane of gamma-ray detectors location; D—the half of the distance between the two gamma-ray detectors installed at the same height.

2. The method according to claim 1, wherein in the control zone an ultrasonic vibrations are emitted in the control zone, ultrasonic vibrations reflected from the controlled object are accepted and converted into electrical signal, the electrical signal is increased, a component of the electrical signal proportional to the distance to the controlled object is selected by a bandpass frequency filter, the said component of electrical signal is detected and smoothed and the moment when the controlled object arrives at a given distance R_{P} from the gamma-ray detectors and the moment when the controlled object moves away from the gamma-ray detectors to a given distance R_{U} are determined by comparing the said component of the electric signal with at least one threshold value established in accordance with the values of the given distance R_{P} and the given the distance R_{U}.

3. The method according to claim 1, wherein an ultrasonic vibrations are emitted in the control zone, ultrasonic vibrations reflected from the controlled object are accepted and converted into electrical signal, the electrical signal is increased, a component of the electrical signal proportional to the speed of the controlled object is selected by a bandpass frequency filter, the said component of electrical signal is detected and smoothed, it compared with the established threshold, and in case of excess of the said component of the electric signal over the threshold the decision is made whether violation of the rules of movement through the control zone by the controlled objects was occurred.

4. The method according to claim 1, wherein an ultrasonic vibrations are emitted in the control zone, ultrasonic vibrations reflected from the controlled object are accepted and converted into electrical signal, the electrical signal is increased, a component of the electrical signal proportional to the intensity of the ultrasonic noise in the control zone is selected by a bandpass frequency filter, the said component of electrical signal is detected and smoothed and resulting smoothed component is subtracted from the electric signal.

5. The method according to claim 1, wherein the magnitude of time interval between the moments of electrical signals shaping by at least with two crossing sensors, which are designed as the source and receiver of optical radiation, placed opposite to each other on the opposite sides with respect to trajectory of controlled object movement in the control zone, and set in the plan at a given distance, is determined, the said magnitude of the time interval is compared with the established threshold, and decision is made about violation of the rules of movement through the control zone by the controlled object when threshold value exceeds the referred time interval.

6. The method according to claim 1 or 5, wherein the current time since the moment of the controlled object detection in the control zone until the moment of forming an electrical signal by at least one crossing sensor is measured, the current time is compared with established threshold, and decision is made about violation of the rules of movement through the control zone by the controlled object if the value of the current time exceeds the established threshold.

7. A radiation portal monitor comprising a two-frame portal, allocated in the portal controller with a connected alarm unit, at least two gamma-ray detectors with series connected incorporated amplifier and analog-digital converter connected to the input of the controller, and object detection sensor, characterised in that it is equipped with an series connected object detection signal amplifier, the first detector, the first smoothing filter and unit of object detection and distance recording that is connected by the output to the input of controller, at that the object detection sensor is designed as a source and receiver of ultrasonic vibrations, and the input of the object detection signal amplifier connected to the output of ultrasonic vibrations receiver.

8. The monitor according to claim 7, characterised in that it is equipped with amplification automatic control unit connected by the input to the output of the first smoothing filter and the object detection signal amplifier is arranged with possibility to adjust its amplification ratio and its amplification control input is connected to the output of amplification automatic control unit.

9. The monitor according to claim 7, characterised in that the said unit of object detection and distance recording contains the series connected a first bandpass frequency filter, a second detector, a second smoothing filter and a distance registration threshold device with a threshold level equals to the value of the electric signal at its input when the controlled object is located at a given distance from the gamma-ray detectors, equals to (0.8−1.2)·(H+D), where H—the height of the horizontal plane which is a symmetry plane of gamma-ray detectors location; D—the half of the distance between the two gamma-ray detectors installed at the same height.

10. The monitor according to claim 7, characterized in that it is equipped with object speed recording unit containing series-connected a second bandpass frequency filter, a third detector, a third smoothing filter and speed registration threshold device, and the input of the said second bandpass frequency filter and the output of the said speed registration threshold device are connected respectively to the output of the first smoothing filter and the input of the controller.

11. The monitor according to claim 7, characterized in that it is equipped with noise recording unit, comprising series-connected third bandpass frequency filter, the fourth detector and a fourth smoothing filter, and the input of the third bandpass frequency filter connected to the output of the first smoothing filter and the output of the fourth smoothing filter connected to the inputs of the first and second bandpass frequency filters.

12. The monitor according to claim 7, characterized in that it is equipped with at least two crossing sensors installed in the alignment of the two-frame portal at the same horizontal plane at the assigned distance from each other, each of which is designed as a optical radiation source and a optical radiation receiver mounted on the opposite frames of the portal across from each other, and with at least two circuits containing series-connected a crossing signal amplifier and a crossing signal threshold device, and the crossing signal amplifier input is connected to the optical radiation receiver output, and the output of crossing signal threshold device is connected to the controller input.
